(19) United States
(12) Patent Application Publication
(10) Pub. No.: US 2026/0050794 A1
(43) Pub. Date: Feb. 19, 2026

(54) TRANSFER LEARNING OF ARRIVAL TIME PREDICTION MODELS FROM A 65 NM TO A 28 NM PROCESS NODE

(71) Applicant: Drexel University, Philadelphia, PA (US)

(72) Inventors: Ioannis Savidis, Wallingford, PA (US); Saran Phatharodom, Philadelphia, PA (US); Pratik Shrestha, Philadelphia, PA (US)

(73) Assignee: Drexel University, Philadelphia, PA (US)

(21) Appl. No.: 19/299,174

(22) Filed: Aug. 13, 2025

Related U.S. Application Data
(60) Provisional application No. 63/683,104, filed on Aug. 14, 2024.

(51) Int. Cl. G06N 3/096; G06N 3/042

(52) U.S. Cl. CPC G06N 3/096; G06N 3/042

(57) ABSTRACT

Methods, systems, and computer-readable media predict post-routing timing metrics in integrated circuit design. A graph-based neural network may be trained on timing path graphs from a first semiconductor process node and adapted to a second node through fine-tuning, layer freezing, or architecture modification. Timing path graphs may be generated from netlist, layout, parasitic, and variation data and processed by a graph-based model to predict downstream metrics from earlier design stages. Certain techniques encompass transfer learning across process nodes, multi-metric adaptation, multi-stage prediction, and automated architecture selection, and are applicable to various semiconductor technology generations.

### BACKGROUND

This disclosure includes 2 subsections grouped under I and II within each section. Each section includes figures, tables, and equations that are preceded by a corresponding section number. For example, the Figures related to Section I all begin with 1.

### I. Background for Transfer Learning of Arrival Time Prediction Models from a 65 Nm to a 28 Nm Process Node

The application of ML to circuit design ranges from predicting downstream performance metrics such as the timing profile, parasitic impedance, power profile, signal slew, routing congestion, and other design quality metrics, to optimizing design stages such as placement, clock network synthesis, and routing.

Adapting machine learning models to a new technology node is a significant challenge, particularly due to the substantial differences between semiconductor manufacturing processes. Such adaptation may be required for any first and second semiconductor process nodes differing by at least one technology generation, including but not limited to 90 nm to 45 nm, 65 nm to 28 nm, and 16 nm to 3 nm.

Machine learning (ML) algorithms are being explored to model various elements and parameters of a circuit, with the potential to revolutionize the way the semiconductor industry approaches design optimization and analysis. The application of ML to circuit design ranges from predicting downstream performance metrics such as the timing profile, parasitic impedance, and power profile, to optimizing design stages such as placement, clock network synthesis, and routing. Adapting machine learning (ML) models to a new technology node is a challenge, particularly due to the large difference between semiconductor manufacturing processes. Transitioning from an older to a more advanced technology node requires modifications to modeling techniques to more accurately predict the behavior of an IC at the advanced node. More precise models are needed to account for improved transistor performance, faster switching speeds, higher heat dissipation per unit area, and quantum mechanical effects.

### II. Background for Graph Representation Learning for Gate Arrival Time Prediction

A significant portion of the run time of modern electronic design automation (EDA) tools is spent on iterative execution of the design flow to meet the target circuit specifications and timing constraints. The different stages of the design flow, as illustrated in FIG. 2.1, include separate estimates of the parasitic impedance and physical characteristics of the circuit, which results in differences in the static timing analysis (STA) of the circuit. The estimates of the path delays during static timing analysis at each design stage require a comparatively shorter amount of time to complete, but significantly affect the quality of the downstream estimates of the path delay. Commercial tools such as Synopsys PrimeTime provide an estimate of the timing profile after each stage, which allows for necessary modifications to the circuit to attain timing closure. With estimates of the timing profile of the circuit, provided at each design stage, preemptive changes to the circuit are possible before completing the given physical design step. Since each design step requires significant computational resources, a predictive tool that provides a good estimate of the delay of the timing paths significantly reduces the design time.

A wide variety of structures are represented as graphs and modeled into a low-dimensional vector embedding using graph-based neural networks (GNNs), which are then used for various learning applications. Circuit netlists represented as graphs leverage structural information to facilitate more comprehensive learning. Although graph-based learning approaches have been used for various EDA tasks such as logic synthesis, placement, and clock tree synthesis, the use of graph-based machine learning techniques has yet to be applied for arrival time prediction.

### SUMMARY OF THE EMBODIMENTS

### I. Background for Transfer Learning of Arrival Time Prediction Models from a 65 Nm to a 28 Nm Process Node

The ability to adapt predictive models from an older to a newer technology node provides an efficient means to design, optimization, and analyze a circuit. This system and method describes transfer learning techniques that adapt arrival time prediction models from a 65 nm technology node to a 28 nm technology node. By leveraging models developed for the 65 nm node, the benefits and challenges of transferring the knowledge gained from the 65 nm node to enhance model performance at the 28 nm node are explored.

Leveraging neural networks with transfer learning provides a means to adapt pre-trained models to a new technology node. The transferred knowledge improves predictions of the behavior of the IC at the more advanced technology node while reducing the amount of data needed to train or fine-tune the models. The utilization of neural networks with transfer learning enables the efficient use of datasets generated from non-target technology nodes, thereby minimizing the need to train models from scratch. Consequently, the use of transfer learning significantly reduces the computational time and resources needed to model circuit behavior in a new technology nodes. In this paper, a transfer learning framework is introduced that adapts a graph-based deep neural regression model from a 65 nm technology node to a 28 nm technology node to predict the post-routing arrival time following the completion of the circuit's floorplanning. A characterization of the performance of the transferred models across technology nodes is performed using six circuits from the IWLS'05 sequential benchmark circuit suite.

### Transfer Learning

Transfer learning leverages knowledge acquired from source domains to enhance performance or prediction in different but related target domains. Assume a domain D includes a feature space X and a probability distribution P (X), with X={x1, . . . , xn} ∈X. For a given task T, defined by a label space Y and a predictive function f(·), the goal of transfer learning is to learn the predictive function f(·) from the domain D that maps input feature vectors to labels in Y. Considering such a problem formulation, model-based transfer learning uses common parameters and structures that enable the transfer of knowledge from one trained model to another, which proves effective for applications that leverage deep learning. A source model, MS, initially trained within the source domain DS for a source task TS, is adapted for a target task TT in the target domain DT through the transfer of knowledge to a target model MT. The key components of model based transfer learning include

Parameter reuse: Parameters used to train the source model MS are used to train the target model MT for the target task TT. Parameter reuse is especially beneficial when the source and target tasks include common underlying structures or patterns.

Architecture reuse: The architecture of the source model is reused and adapted for the target task. Model adaptation includes adding, removing, or modifying layers within the neural network.

Fine-tuning: The model trained for the source task is further trained (or fine-tuned) on the target task. Fine-tuning typically uses a lower learning rate and/or a smaller number of epochs to prevent the loss of generalized features learned from the source task.

Freezing layers: Select layers of the neural network model are kept static or “frozen” during fine-tuning, which is achieved by not updating the weights of the layers. The technique is used to preserve knowledge learned from current data in the earlier layers of a neural network, which typically learn more general features, while allowing the later layers of a neural network to adapt to the specific data of the target task TT.

### II. Background for Graph Representation Learning for Gate Arrival Time Prediction

An accurate estimate of the timing profile at different stages of the physical design flow allows for pre-emptive changes to the circuit, significantly reducing the design time and effort. A graph-based deep regression model is used to predict the gate-level arrival time of the timing paths of a circuit. Three scenarios for post routing prediction are considered: prediction after completing floorplanning, prediction after completing placement, and prediction after completing clock tree synthesis (CTS). A commercial static timing analysis (STA) tool is used to determine the mean absolute percentage error (MAPE) and the mean absolute error (MAE) for each scenario.

A graph-based regression framework is introduced to predict gate arrival time. The framework uses a timing path-based graph representation that includes node features populated from the circuit netlist and the STA reports to predict path delay at different phases of physical design. Arrival time prediction is performed for three primary scenarios:
a) postcompletion of the floorplan to predict post-completion of routing;
b) post-completion of placement to predict post-completion of routing, and
c) post-completion of CTS to predict post-completion of routing.

The system and method herein include:
Error characterization of a commercial STA tool to determine the mean absolute percentage error (MAPE) and mean absolute error (MAE) of the arrival time predictions as a baseline,
A netlist to graph and timing path to graph representation with embedded node feature attributes,
A graph-based deep neural regression model to predict the arrival time of a signal to a gate within a given timing path. A comparison is made against the baseline and a shallow linear model (linear regression), and
Feature importance analysis on the neural models using GNNExplainer.

In some embodiments, the techniques disclosed herein enable adaptation not only for the same target metric (e.g., gate arrival time) but also for different metrics between nodes, such as leveraging a model trained for arrival time in one node to support prediction of power, slew, or interconnect capacitance in another node.

### BRIEF DESCRIPTION OF THE DRAWINGS

FIGS. 1.1a and 1.1b show the post-floorplan and post-routing arrival time estimates provided by PrimeTime for datasets generated from a (FIG. 1.1a) 65 nm technology node and (FIG. 1.1b) 28 nm technology node.

FIG. 1.1.1 shows Table 1.1.

FIG. 1.1.2 shows Table 1.2.

FIG. 1.1.3 shows Table 1.3.

FIG. 1.1.4 shows Table 1.4.

FIG. 1.1.5 shows Table 1.5.

FIG. 1.2 shows a dataset generation and transfer learning framework for post floorplan to post routing arrival time prediction across technology nodes.

FIG. 1.2.1 shows Equations 1.1-1.3.

FIGS. 1.3a and 1.3b show benchmark representations of a (FIG. 1.3a) netlist graph NG and (FIG. 1.3b) a subset of timing path graphs TPG.

FIGS. 1.4a-1.4c show graph regression network architecture for the (FIG. 1.4a) source models, (FIG. 1.4b) baseline models, and (FIG. 1.4c) target models.

FIGS. 1.5a-1.5c show expected and predicted arrival time for models considered under (FIG. 1.5a) Scenario I (28 nm model), (FIG. 1.5b) Scenario II (predicting 28 nm arrival times using the 65 nm model), and (FIG. 1.5c) Scenario III (65 nm to 28 nm transfer model).

FIG. 2.1 shows a physical design automation flow.

FIG. 2.1.1 shows Table 2.1.

FIG. 2.1.2 shows Table 2.2.

FIG. 2.1.3 shows Table 2.3.

FIG. 2.1.4 shows Table 2.4.

FIG. 2.1.5 shows Table 2.5.

FIG. 2.1.6 shows Table 2.6.

FIGS. 2.2a and 2.2b show histograms (in log scale) of (FIG. 2.2a) gate arrival time, and (FIG. 2.2b) timing path depth.

FIG. 2.2.1 shows Equations 2.1-2.5.

FIGS. 2.3a-2.31 show PrimeTime based initial and final phase arrival time estimates for (FIG. 2.3a) all circuits from floorplan to routing, (FIG. 2.3b) all circuits from placement to routing, (FIG. 2.3c) all circuits from CTS to routing, (FIG. 2.3d) small circuits from floorplan to routing, (FIG. 2.3e) small circuits from placement to routing, (FIG. 2.3f) small circuits from CTS to routing, (FIG. 2.3g) medium circuits from floorplan to routing, (FIG. 2.3h) medium circuits from placement to routing, (FIG. 2.3i) medium circuits from CTS to routing. (FIG. 2.3j) large circuits from loorplan to routing, (FIG. 2.3k) large circuits from placement to outing, (FIG. 2.31) large circuits from CTS to routing.

FIG. 2.4 shows path delay dataset generation and prediction framework.

FIG. 2.5a-2.5c show machine learning network architectures, which include (FIG. 2.5a) deep GCN network, (FIG. 2.5b) wide and deep GCN network, and (FIG. 2.5c) linear regression.

### DETAILED DESCRIPTION OF THE EMBODIMENTS

### I. Description for Transfer Learning of Arrival Time Prediction Models from a 65 Nm to a 28 Nm Process Node

### Dataset and Baseline Evaluation Analysis

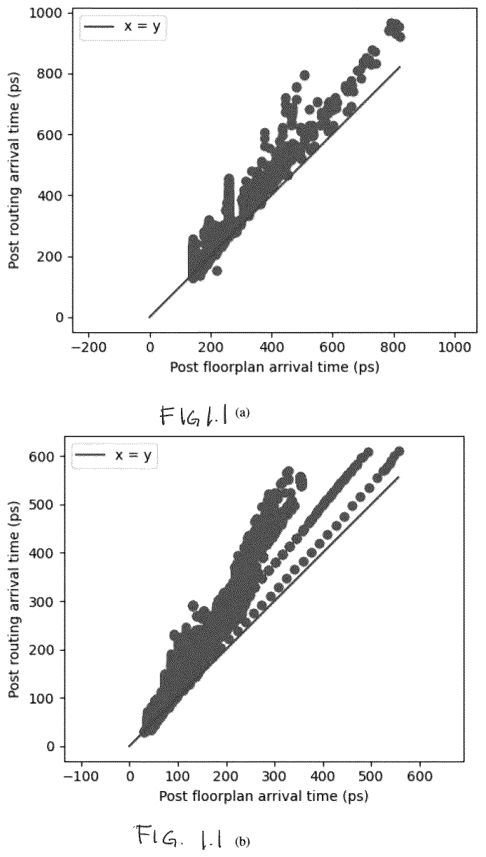

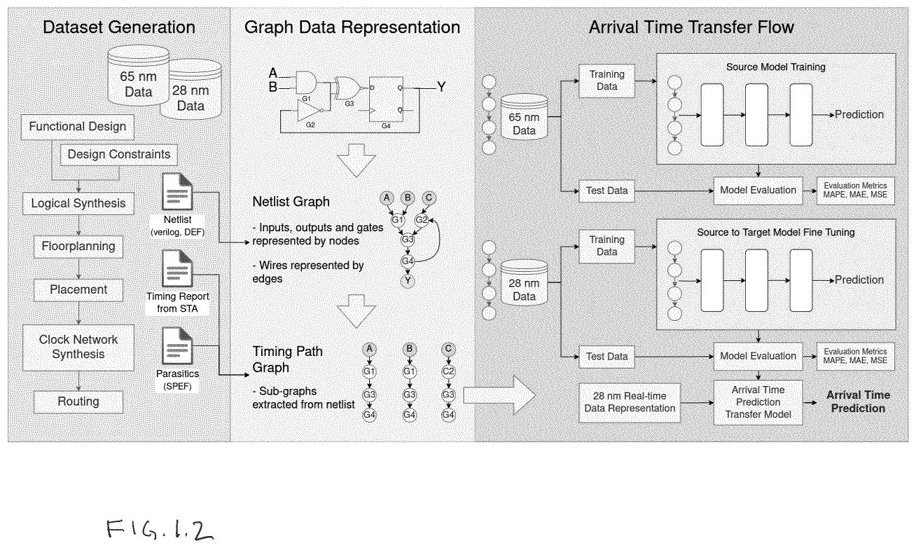

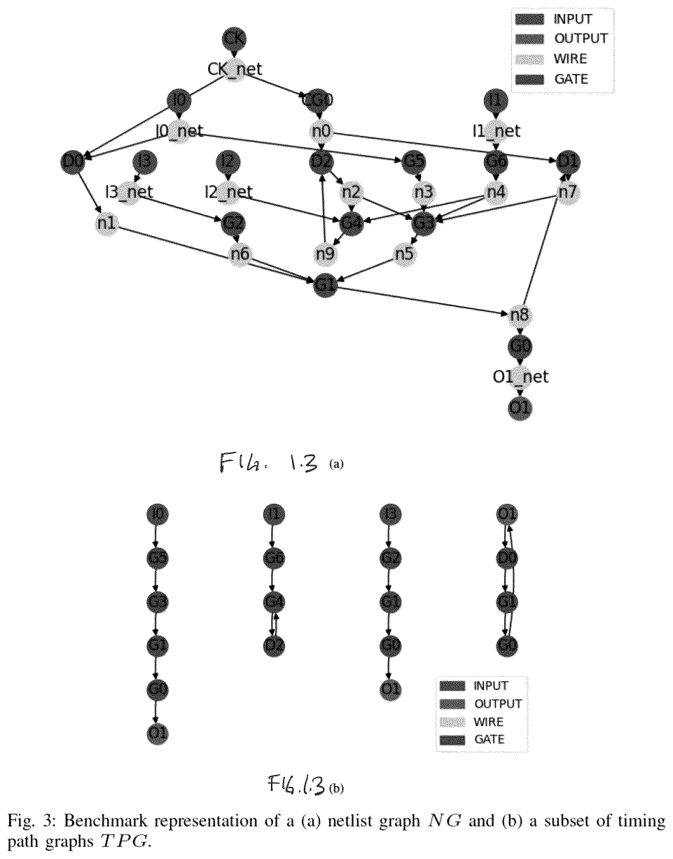

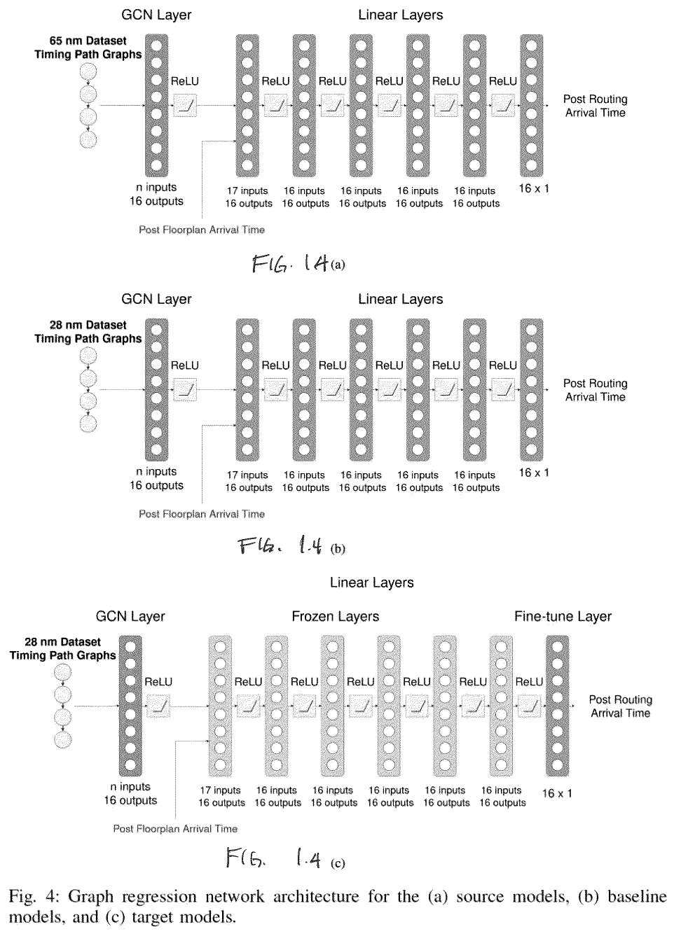

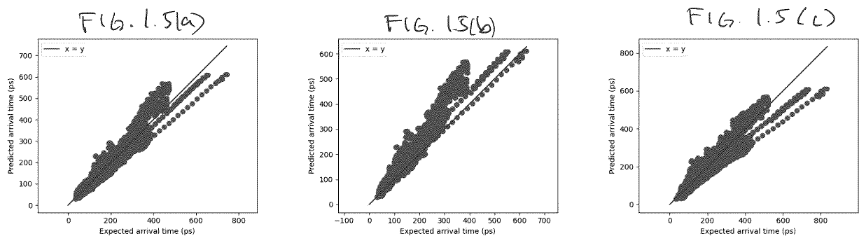

In this section I, six IWLS'05 sequential benchmark circuits listed in Table 1.1 (FIG. 1.1.1), are used to construct two separate datasets of circuit layouts using both the 65 nm and the 28 nm production-ready technology nodes. Synopsys Design Compiler is used to synthesize the initial benchmark circuits into a technology-specific gate-level netlist, while Synopsys IC Compiler is used to place and route the gate-level netlist Static timing analysis is performed on the generated circuits using Primetime at each stage of the physical design flow. Interconnect parasitics are extracted by Synopsys IC Compiler and are stored in Standard Parasitic Exchange Format (SPEF) files, with data from the files used to develop model features. The circuits are synthesized with target design parameters that include an operating frequency of 1 GHz, a circuit aspect ratio of 0.5, and an occupied area of 70% of the total.

For each technology node the post floorplan arrival time provided by the design tool is considered as the baseline prediction for the post routing timing profile. Scatter plots of the post floorplan and post routing arrival time of the 65 nm dataset and the 28 nm dataset are shown in FIG. 1a and FIG. 1b, respectively. The metrics evaluating the error, specifically the mean absolute percentage error (MAPE) and mean absolute error (MAE), are used for analysis and comparison. The MAPE and MAE are given by, respectively, Equations 1.1 and 1.2 (FIG. 1.2.1), where n is the total number of timing paths in the dataset, y is the arrival time post routing, y\hat{ } is the arrival time post floorplan, and y⁻ is the average arrival time post routing. The baseline MAE and MAPE errors for each of the circuits are listed in Table 1.3 and Table 1.4 (FIGS. 1.1.3 and 1.1.4), respectively. The scatter plots and the baseline evaluations indicate significant error between the arrival time provided from the two different design stages. The MAE and MAPE for the 28 nm target dataset is, respectively, 20.34% larger and 123.07% larger than that of the 65 nm source dataset.

Timing path graphs may be generated from Verilog netlists, DEF files, GDSII files, SPEF parasitic files, static timing analysis reports, and optionally manufacturing variation datasets.

Environmental or process variation data such as thermal profiles, voltage drop maps, or process corner parameters may be included as node or edge features.

Spatial features may include placement coordinates (x, y), routing topology encodings, and learned spatial embeddings derived from such physical design attributes.

### Methodology for Arrival Time Prediction

In this section, a transfer learning framework is proposed to adapt a model that predicts the arrival time of the logical paths of a circuit from a 65 nm technology node to a 28 nm technology node. Three key models are trained and evaluated: a source model, a baseline model, and a target transferred model. The source model, trained and evaluated on a dataset generated in a 65 nm technology, serves as the foundation for a model fine tuned in a 28 nm technology node. A model that is trained and evaluated on a dataset generated in a 28 nm technology node is used as a baseline for comparison, providing a reference against which the transferred model is measured. All models are trained using the same graph structure and use identical feature sets and feature engineering methodologies, as detailed in Section A. The source, the baseline, and the fine-tuned target models are described in Section B. The overall execution of the framework and the training flow is shown in FIG. 1.2.

### A. Graph Structure and Feature Engineering

The generated dataset is mapped onto EDA-Schema, a graph data model for machine learning applications in design automation. EDA-Schema enables the representation of a circuit's netlist and timing path graph, extracted from the completed stages of the physical design flow. The physical characteristics of the circuit, described in the Verilog and DEF files, are mapped to a netlist graph G=(V,E), where node v∈V represents inputs, outputs, and gates of a netlist and edge e∈E represents a wire connecting two node components. Subgraphs of the timing paths, described as timing path graphs TPG=(V,E), are derived from the netlist graph NG (FIG. 1.3a), as shown in FIG. 1.3b. The timing path subgraphs serve as the primary inputs to a model that predicts the arrival times of gates of a given timing path. Each node of a timing path subgraph is populated with a carefully selected feature set extracted from the netlist and STA timing reports. The feature set of the nodes of the timing paths is listed in Table 1.2 (FIG. 1.1.2).

### Source, Baseline, and Target Model Architectures

A wide and deep graph neural architecture is used to predict the arrival time. The regression model includes a graph convolution layer (GCN) connected to six linear layers of size 16. The neural network takes timing path graphs as input. Each hidden layer uses a rectified linear unit (ReLU) as an activation function. A gradient clipping of weights greater than one is applied after each execution of the activation function to avoid exploding gradients. The primary objective function is to minimize the mean squared error (MSE) loss between the actual post routing arrival time y and the predicted estimate of the post routing arrival time y\hat{ }. The MSE loss is given by Equation 1.3 (FIG. 1.2.1), where n is the total number of gates in all of the timing paths of the dataset. Two identical neural networks are separately trained on datasets generated in the 65 nm and 28 nm technology nodes as, respectively, the source and baseline models, which are shown in FIG. 1.4a and FIG. 1.4b. The architecture of the source model is modified to implement the architecture of the target model, which is shown in FIG. 1.4c. The neural network architecture of the target model allows for fine-tuning with transfer learning. The weights of all layers of the source model are frozen to retain the knowledge learned from the 65 nm dataset. An additional layer of size 16 is added beyond the frozen layers of the source model that represents the final layer of the neural network implementing the target model. The weights of the final layer are fined tuned using the 28 nm dataset, which adapts the 65 nm model to the new technology node.

The dataset generated based on the six circuits listed in Table 1.1 is used for six instances of the source 65 nm deep regression model and six instances of the baseline 28 nm deep regression model. For each instance of the model, one circuit is considered as the test set, and the remaining five circuits are considered as the training set. Each model instance is trained with a stochastic gradient descent (SGD) optimizer for 100 epochs and a batch size of 1024 interconnect graphs for a single iteration of training and validation. An initial learning rate of 0.01 is applied that decays at a rate of 95% every 10 training steps. Early stopping is adopted such that the training process is terminated when there is no improvement in the training loss for 10 epochs, which prevents the model from overfitting to data features by learning the statistical noise in the training dataset. The proposed target deep regression model, which includes an additional layer beyond the frozen 65 nm trained model layers, is fine tuned utilizing the 28 nm dataset for 20 epochs, while utilizing an identical initial learning rate and an identical decay rate as the source model. The framework is implemented in Python 3 using the PyTorchgeometric deep learning library. The training is performed on a system with 96 GB memory, twenty four 4 GHz CPU cores, and an NVIDIA Geforce GTX 3090 graphics card.

The source model, trained on the second process node, may be adapted using fine-tuning, partial layer freezing, architecture modification, or re-parameterization of weights. In one embodiment, all layers of the source model are frozen and a new fine-tunable layer is added, the layer comprising between 8 and 128 neurons.

Optimization algorithms may include stochastic gradient descent, Adam, or RMSProp, with a learning rate between 0.001 and 0.05 and a decay rate between 85% and 99%.

The adaptation process may result in a mean absolute percentage error reduction of at least 20%, or more, compared to direct use of the unadapted source model.

In another embodiment, a plurality of graph-based neural network architectures is evaluated, and the architecture achieving the highest validation accuracy for the target process node is selected automatically.

### Results of Model Characterization

In this section, an analysis is provided of the results returned by the transfer learning framework for the prediction of arrival time, the methodology of which is described herein. Four scenarios are considered that account for the availability of both data and models from the 65 nm and 28 nm technology nodes. The scenarios include:
Preliminary Scenario: Initial 65 nm model

The training and prediction on the source technology node is assumed already complete. Therefore, the entire dataset and fully trained models for the 65 nm source technology node are assumed available.
Scenario I: 28 nm model

A dataset for the 28 nm target technology is generated. A 28 nm baseline model is fully trained using the generated dataset. No transfer learning is attempted.
Scenario II: Predict 28 nm arrival times using the 65 nm model

The dataset for the 28 nm technology node is not generated. The source 65 nm models are used directly for the prediction of the target 28 nm arrival times without transfer learning.
Scenario III: Transfer model (65 nm to 28 nm)

The dataset for the 28 nm technology is generated. The source 65 nm model is fine tuned on the 28 nm dataset, transferring knowledge from the 65 nm node to the target 28 nm node.

The trained regression models are validated against the test datasets. The MAE and MAPE for each prediction scenario are calculated for comparison of the models, with the results listed in Table III and Table IV, respectively. Both the 65 nm and 28 nm models outperform the respective baselines, demonstrating the efficacy of the GCN model architecture. The 28 nm models result in less error as compared to the 65 nm models on average, indicating that the graph neural network provides better predictions for the 28 nm node under identical circumstances. However, when analyzing the graph neural network model of each circuit independently, the 65 nm model outperforms the 28 nm model for certain circuits (aes core,pci). Comparing the MAE and MAPE for the three scenarios used to characterize the accuracy of the models that predict the gate arrival time in the 28 nm node, the baseline models considered under Scenario I perform the best on average across all the models as training is completed directly on 28 nm data.

The baseline model demonstrates an average of 43.73% lower MAE and 42.69% lower MAPE as compared to the 65 nm source model used directly for 28 nm prediction as described by Scenario II. An outlier prediction of the arrival time is observed for usb funct, where the model considered under Scenario II outperforms the model considered under Scenario I. The target model considered for Scenario III also outperforms the source model used for Scenario II with the exception of the usb funct and des3 perf circuits, showing an average improvement of 38.49% in MAE and 28.16% in MAPE. The accuracy of the predictions provided by the models is also characterized by comparison of the estimated and predicted arrival times for Scenarios I, II, and III as shown in FIG. 1.5a, FIG. 1.5b, and FIG. 1.5c, respectively. When analyzing the prediction provided by models for individual circuits, the transfer models considered under Scenario III for aes core, wb conmax, usb funct, and pci outperform the respective baseline models considered under Scenario I. From the four circuits that outperform the baseline models, aes core and pci were tuned on source GCN models that already performed better than the predicted arrival times provided by the baseline GCN models.

Although the baseline model considered under Scenario I is the most accurate amongst the models trained for each scenario, significantly more time and resources are required for training. A relative comparison of the time required to generate data and train models for each Scenario is also provided, with the results as listed in Table 1.5, FIG. 1.1.5. The source model considered under Scenario III requires no additional data generation or modeling. For Scenario I, generating a 28 nm dataset and training the models requires 4 hours and 23 minutes. In comparison, for the target transfer models considered under Scenario II, although generation of the dataset requires 1 hour and 25 minutes, the fine tuning of the models only requires an additional 4 minutes. Therefore, the transfer model considered for Scenario III is more accurate than the target models considered for Scenario II and requires less time to train as compared to the baseline models considered under Scenario I.

While much of the evaluation herein focuses on gate arrival time prediction, the same architecture and adaptation methodology are applicable to other timing and physical metrics, such as total power, interconnect capacitance, and signal slew.

For example, a source model trained on arrival time in a 65 nm node may be adapted to predict power in a 28 nm node with similar gains in mean absolute percentage error reduction.

### Conclusions

In this Section, a transfer learning framework that fine tunes a graph-based deep neural regression model is introduced. The framework adapts a source model that predicts the postrouting arrival time after floorplanning of a circuit in a 65 nm technology node to a target model that predicts the post-routing arrival time for the same circuit implemented in a 28 nm technology node. Datasets are generated using a commercial physical design tool for timing path graph representations of six post-floorplan IWLS'05 benchmark circuits, followed by an analysis to establish a baseline error across the six circuits. A baseline transfer learning scenario is considered, where prediction on 28 nm circuits is performed using the 65 nm GCN model directly with no fine-tuning. The transferred models provide better prediction performance as compared to the 65 nm models without the need for further fine-tuning, achieving an average improvement of 38.49% in Mean Absolute Error (MAE) and 28.16% in Mean Absolute Percentage Error (MAPE), while requiring an additional 1 hour and 40 minutes for data generation and model tuning. Models trained specifically on 28 nm data outperform the transferred models, providing an average improvement of 8.51% in MAE and 20.22% in MAPE, but require an additional 2 hours and 47 minutes for data generation and model tuning. The evaluated results highlight the effectiveness of transfer learning in reducing the time and resources needed to adapt models across different semiconductor technology nodes, suggesting a promising strategy towards more efficient and accurate predictive modeling techniques. The disclosed framework enables efficient adaptation of graph-based neural network models across semiconductor technology nodes and across target prediction metrics. By integrating feature sets that include environmental and spatial embedding data, and by supporting training from multiple earlier design stages, the disclosed methods improve accuracy and generalizability while reducing data generation time.

### II. Description for Graph Representation Learning for Gate Arrival Time Prediction

### INTRODUCTION

### 1. Machine Learning for Gate Level Path Delay Estimation

One area of prior work explores applying machine learning (ML) to timing analysis to reduce the miscorrelation between two timing analysis tools that return different results for the same circuit netlist. In one approach, a learning-based approach is used to fit correlation-based ML models of wire slew and delay to estimates from a signoff STA tool. A deep hierarchical model may be used to predict the path delay of an unexecuted commercial EDA tool from the timing analysis of a commercial tool that was used. A support vector machine (SVM) was used during floor planning for the prediction of post-layout timing failures of embedded memory in one approach. A random forest-based approach is proposed another to predict the pre-routing timing profile of a circuit designed in and analyzed by a commercial EDA tool. An artificial neural network has been proposed to predict the statistical static timing analysis (sSTA) profile of a circuit characterized by a commercial STA tool. Previous approaches for timing prediction generally target a single stage of the overall design flow. Although structural features are used in prior work, the structural information provided by the connectivity relationship between two or more components of a netlist graph has not been explored in the context of timing profile prediction.

### 2. Graph Representation Learning and Neural Network Explanation

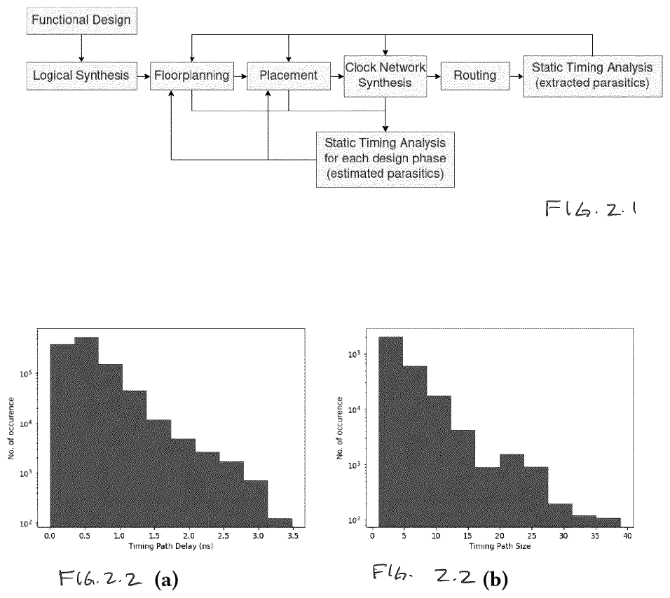

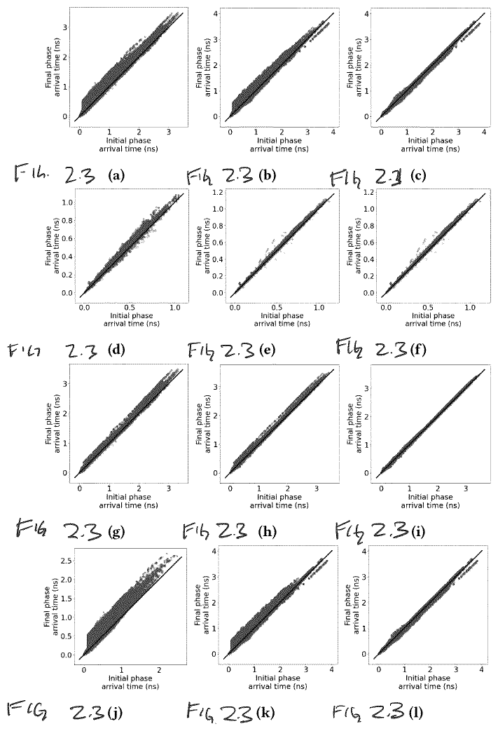

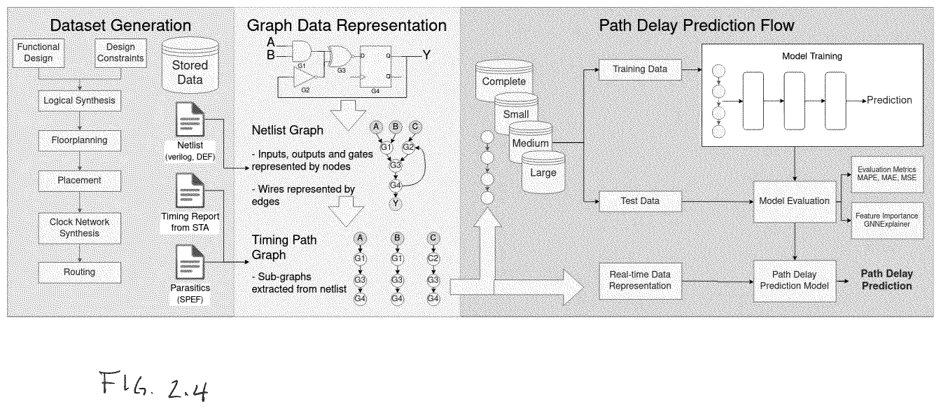

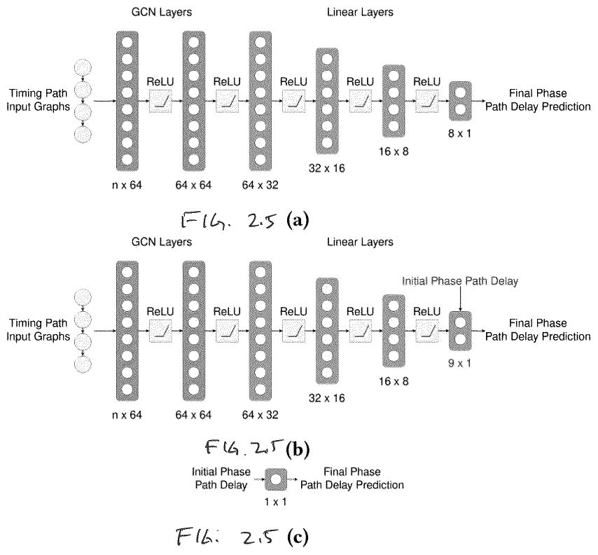

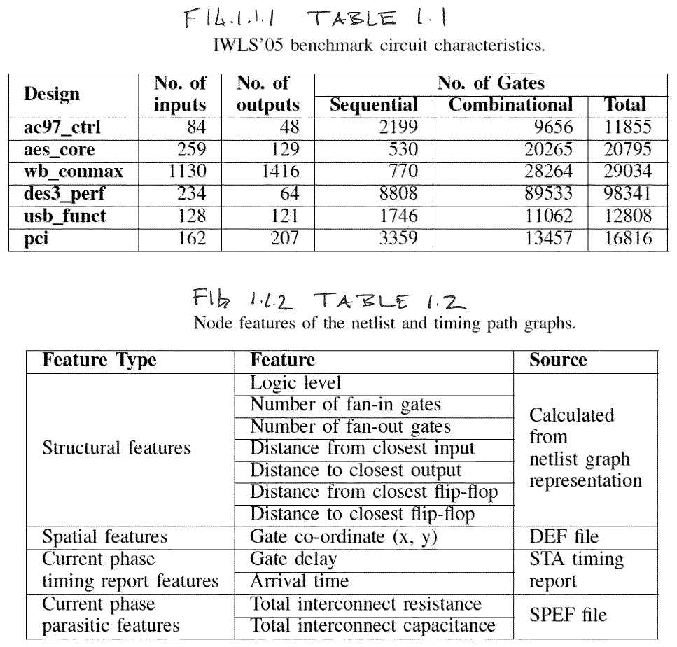

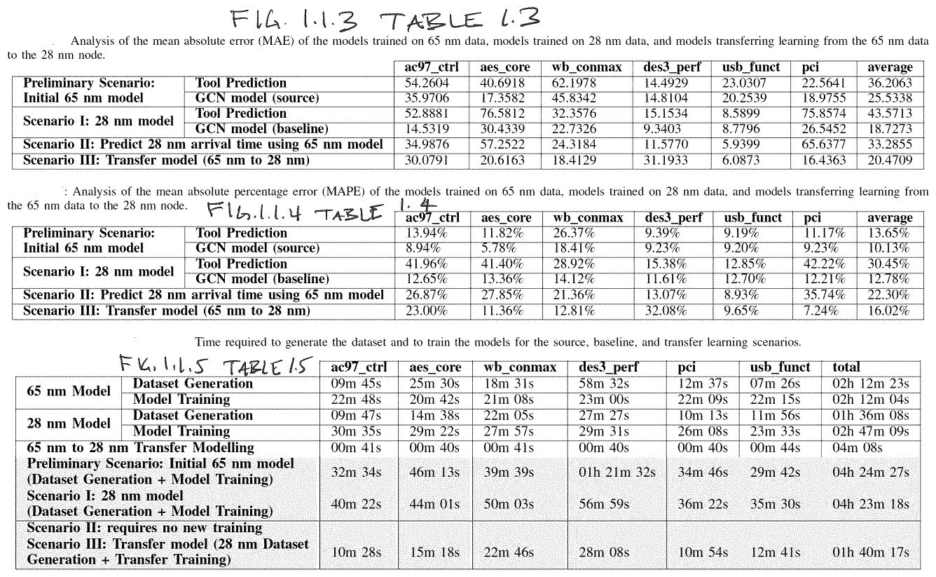

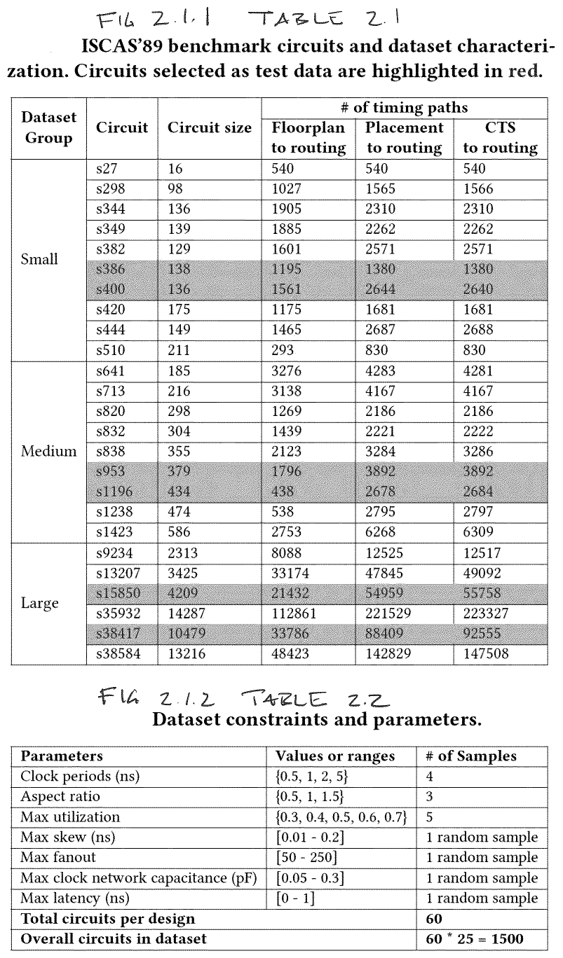

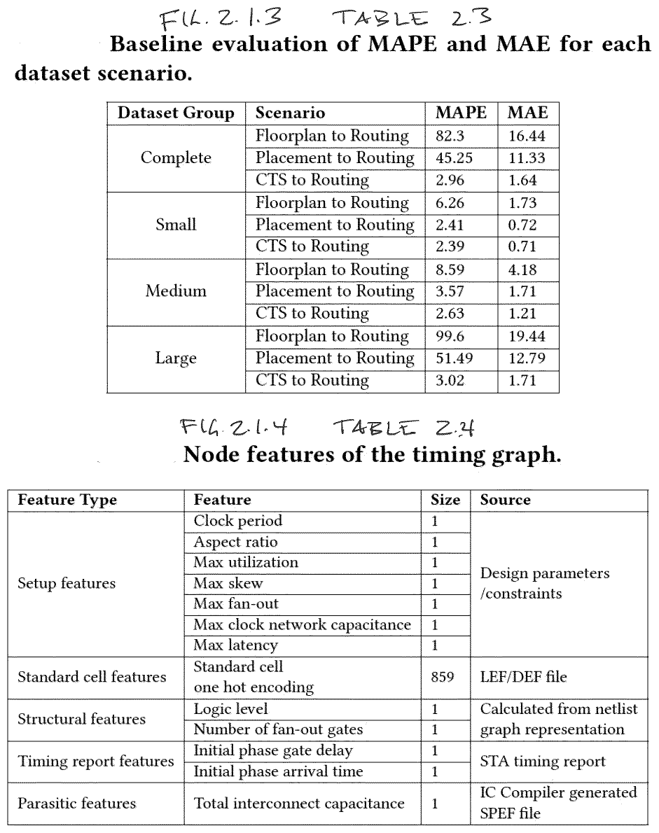

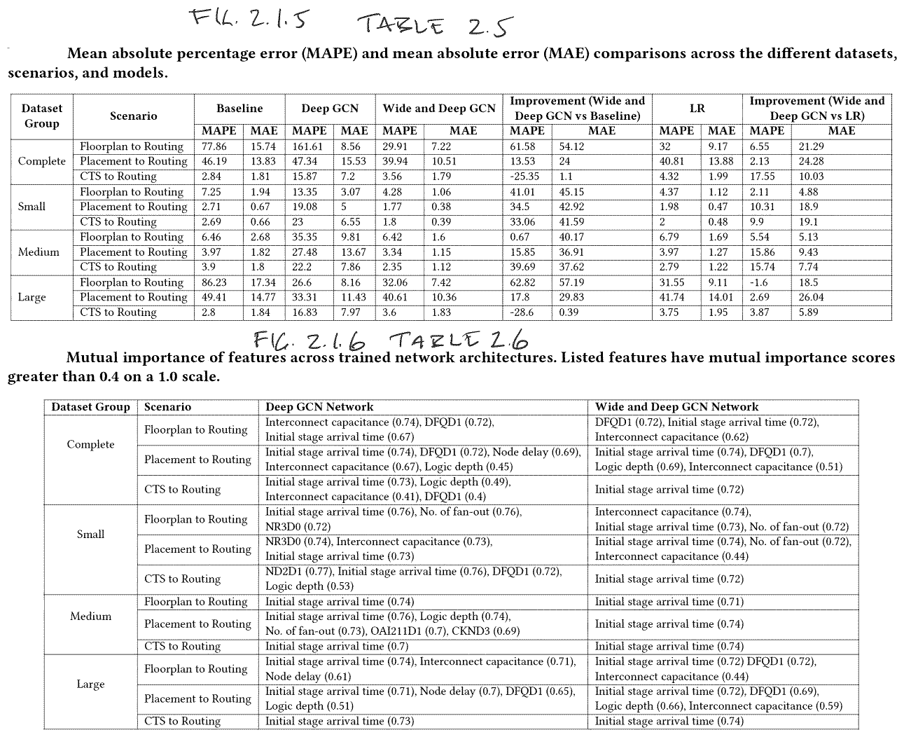

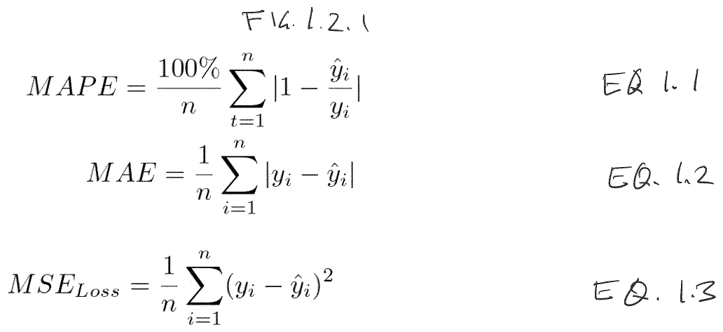

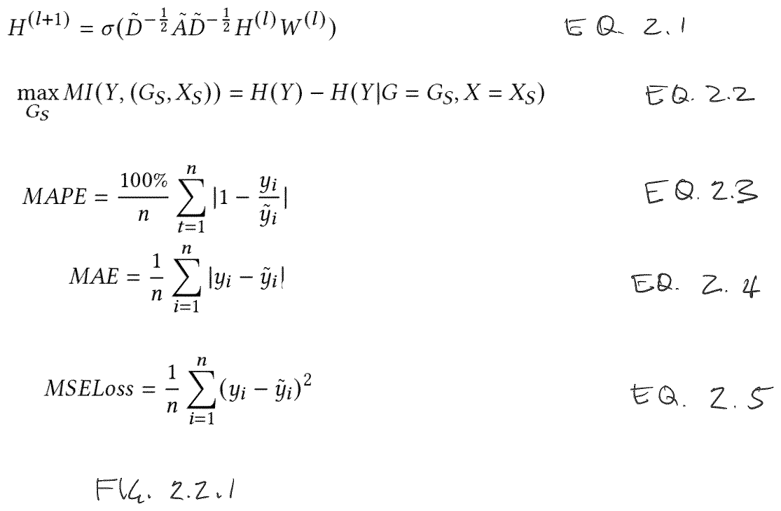

In this Section, graph convolutional layers (GCN) are used to model gate delay from timing path graphs. Convolution functions multiply the input neurons with a set of weights commonly known as filters or kernels. Given a directed graph G=(V,E), where v∈V is a node of the graph, e∈E is an edge of the graph, and A denotes the adjacency matrix, the graph convolution layer is defined as shown in Equation 2.1, FIG. 2.2.1, where σ is an activation function. The adjacency matrix of the graph G\tilde{ } is given by A\tilde{ }=A+IN, where G\tilde{ } is equivalent to the graph G with added self-connections on each node. IN represents the identity matrix and D\tilde{ } the diagonal degree matrix for A\tilde{ }. H(l) and W(l) are, respectively, the node embedding matrix and trainable weight matrix for the lth layer. The input embedding layer of the network is H 0=X, where X represents the node features of the graph.

One challenge with GCNs is the inability to comprehensively characterize the operation of the neural model after training. AI algorithms such as GNNExplainer provide interpretable explanations of predictions by a GNN-based model by reducing redundant information in a graph that does not directly impact the prediction(s). GNNExplainer provides such explanations by maximizing mutual information (MI), a measure of the mutual dependence between the node feature set X and the predicted node target value Y of the corresponding minimal graph Gs of the computational graph G as defined by Equation 2.2 (FIG. 2.2.1).

The graph-based model may comprise a graph convolutional network, a graph attention network, a message-passing neural network, or a hybrid of such layers with dense layers.

The earlier design stage for prediction may be post-floorplanning, post-placement, post-clock-tree-synthesis, or post-global-routing.

In some embodiments, the model is trained for multiple earlier stages simultaneously (e.g., floorplan and placement), and the outputs from multiple stage-specific predictors are combined via an ensemble method to produce a final post-routing prediction.

### Dataset Design and Baseline

### 1. Dataset Generation

In this Section, ISCAS'89 sequential benchmark circuits are used to build a dataset of physical designs and timing paths. The dataset is generated on a TSMC 65 nm technology. The initial benchmark circuit is synthesized into a technology-specific gate-level netlist using Synopsys Design Compiler. Synopsys IC Compiler is used for floor planning, placement, CTS, and routing. Multiple layouts are generated for each benchmark circuit by utilizing parameterized design constraints. PrimeTime is used to perform static timing analysis on the generated logical and physical design at each stage of the design flow. Timing paths, gate delays, and input/output delays are extracted from the timing report generated by PrimeTime for each stage of the design process.

The ISCAS'89 benchmark circuits used for the data generation are listed in Table 2.1 (FIG. 2.1.1), and the parameters used as design constraints are listed in Table 2.2 (FIG. 2.1.2). A total of 1500 physical designs are generated for the 25 benchmark circuits (60 per circuit).

### 2. Baseline Path Delay

Given the initial (floorplan) and final (routing) stages of the IC physical design flow, the timing profile of the initial stage provided by the STA tool is considered as the baseline prediction for the timing profile of the final stage. Specifically, for a post-floorplan to post-routing prediction, the estimates of the arrival time of logical paths of the post-floor planned circuit are treated as the baseline for the same timing paths after routing.

Histograms of both the post-routing gate arrival time and post routing timing path depth (number of gates in a timing path) for the entire dataset are shown in FIGS. 2.2a and 2.2b. There is a large variation in the size of the benchmark circuits, and a significantly left-skewed logarithmic distribution of the timing path depth is observed. To balance the dataset, all data points are further divided into three categories, small, medium, and large, based on both the total number of gates and the total number of inputs and outputs in the circuit. From the overall dataset, six circuits and all parameterized designs and timing paths of the selected circuits are separated as testing sets. The distribution of the timing paths across the small, medium, and large circuits are listed in Table 2.1 (FIG. 2.1.1). The circuits selected for the test set are highlighted and in red font in Table 2.1.

Scatter plots of the initial and final stage estimates of the path delay for the small, medium, large, and entire dataset and for each of the three scenarios described are shown in FIG. 2.3a-2.31. There is a significant error between the timing estimates provided from two different design stages. The error in the estimated timing is the largest when predicting the post-routing path delay after floor planning, smallest for predicting the post routing path delay after CTS, and greater for circuits with larger size. The metrics evaluating the error, specifically MAPE and MAE, are selected as a baseline and are calculated as, respectively, in Equations 2.3 and 2.4 (FIG. 2.2.1), where n is the total number of gates in the overall dataset, y is the STA delay estimate for the initial design stage and y\tilde{ } is the STA delay estimate for the final stage. The baseline errors for all 12 models are listed in Table 3.3 (FIG. 2.1.3).

### Graph Based Arrival Time Prediction

To predict the arrival time of the gates of a timing path, the timing paths extracted from the physical implemetation of the circuit (DEF file) are mapped into a directed graph and populated with node features extracted from the netlist and STA timing reports.

### 1. Graph Structure and Feature Engineering

The overall flow of the framework and training process is shown in FIG. 2.4. The physical characteristics of the circuit, described in the Verilog and DEF files, are parsed and represented as a netlist graph G=(V,E), where node v∈V represents inputs, outputs, and gates of a netlist and edge e∈E represents a wire connecting two node components. Subgraphs of the timing paths are extracted from each netlist graph utilizing timing reports generated from the STA tool. The subgraphs of the timing paths represent primary inputs to the model. Each node of a timing path subgraph is populated with a carefully selected feature set, which is listed in Table 2.4, FIG. 2.1.4. Setup features are design constraints used by DC compiler and IC compiler during physical design. Standard cell features represent the gate functionality of each node of the timing path using a onehot encoding vector of all cells of a specific technology node (TSMC 65 nm for this work). The overall cell information is extracted from a technology-specific LEF file. Netlist graphs are traversed to compute structural features, whereas timing features are extracted from the timing reports generated by the STA tool and mapped into the circuit netlist. Parasitic features are net capacitance values extracted from the SPEF files generated by IC Compiler. Although edges represent wires in the graph, the total capacitance of a net is set as an attribute of a node, which results in the net being represented by the edge following a given node. The allowed range of capacitances at the output nodes is provided as a constraint during circuit synthesis.

### 4.2 Model Architecture and Training

After completing feature extraction and graph representation of the circuit, a regression model is developed to predict the gate arrival time. The regression model, as shown in FIG. 2.5a, is a deep neural network includes two GCN layers connected to four linear layers. Each hidden layer uses a rectified linear unit (ReLU) as an activation function. The primary objective function is to minimize the mean squared error (MSE) loss between the estimate of the STA delay for the initial design stage, y, and the estimate of the STA delay for the final design stage, y\tilde{ }. The MSE loss is defined as shown in Equation 2.5, FIG. 2.3.1, where n is the total number of gates in the overall dataset.

As listed in Table 2.3 (FIG. 2.1.3), the estimates of the arrival time for the initial stage (floorplanning) are an important feature for the estimates of the final stage arrival time (post-routing). Although the objective of the model is to learn complex non-linear features by leveraging the structural attributes of the graph, wide and deep models that include simultaneous interactions between low and high order features provide better. Therefore, a second regression model is developed where the estimates of the arrival time of the initial stage are added as an additional input to the final layer of the neural network. The perceptron added to the output layer acts as a generalized linear wide component, whereas the remaining layers act as the deep component of the overall network. The network architecture of the wide and deep regression model is shown in FIG. 2.5b. Including the estimated path delay from the initial stage as an input of the final layer heavily biases the prediction. The model is expected to learn from both the co-linearity between the arrival time of the initial and final stage and the non-linear characteristics of the overall graph features. To analyze whether the performance of the model is solely based on the linear relationship between the estimated arrival time of the initial and final stage, a linear regression model, shown in FIG. 5c is used, where only the initial stage estimate is used as a feature to predict the final stage path delays.

### Results

The proposed neural regression models are trained with a stochastic gradient descent (SGD) optimizer on the training dataset listed in Table 2.1. Since the complete dataset of timing paths is too large to train all at once, the dataset is divided into batches of 256 timing paths each for a single iteration of training and validation. An initial learning rate of 0.1 is applied that decays at a rate of 95% every 10 training steps. Early stopping is triggered when there is no improvement in the training loss for over 10 epochs, which both terminates the training process as the model stops generalizing and prevents the model from overfitting by not learning the statistical noise in the training dataset. The framework is implemented in Python 3 using the PyTorch-geometric deep learning library, and the training is performed on a system with 96 GB memory, twenty-four 4 GHz CPU cores, and an NVIDIA Geforce GTX 1080 graphics card.

The trained regression models are validated against the test dataset. MAPE and MAE are calculated for model comparison, with the results listed in Table 2.5 (FIG. 2.1.5). From the MAPE scores listed, the baselines in all scenarios are consistently outperformed by the wide and deep GCN model except for the post-CTS to post routing path delay prediction for the complete and large datasets. The dataset groups that comprise larger circuits result in more variations in the path delay, as shown in FIG. 3, and are more challenging to model accurately. The wide and deep GCN models, therefore, perform better for small and medium circuit datasets as compared to large circuit datasets. The average MAPE for the wide and deep GCN models for the small, medium, and large circuits is 2.61%, 4.03%, and 25.34%, respectively. In addition, the difference between the post-CTS and post-routing estimated path delay is minimal as compared to the difference between the post floorplanning to post routing prediction and post-placement to post routing prediction. The average baseline MAPE for post-CTS to post routing prediction is 3.05% as compared to an average baseline MAPE of 44.45% and 25.57% for, respectively, post floorplanning to post routing prediction and post-placement to post routing prediction. The baseline model is, therefore, performing very well, which leaves less room for gain when predicting post-routing path delay after completing CTS.

The linear model, similar to the wide and deep GCN, also outperforms the baseline in the same scenarios; however, underperforms the wide and deep GCN for all scenarios except for the post-floorplan to post-routing arrival time prediction of large circuits, where a 1.6% improvement is observed for the given single case. When comparing the MAPE between the arrival time predicted by the wide and deep GCN model and the linear model, an average improvement of 2.9%, 12.18%, and 15.7% is observed for post-floorplanning to post-routing prediction, post-placement to post-routing prediction, and post-CTS to post-routing prediction, respectively. Although the deep GCN model converges, indicating some learning, the resulting predictions are consistently worse than the baseline. The MAE calculation of the deep GCN models behaves similar to the MAPE, which re-enforces the insights observed from the analysis of the MAPE of the models.

An additional advantage of utilizing graph neural networks is the ability to apply a diverse set of inputs to the model and obtain insights by analyzing the important features of the model. GNNExplainer is used to measure the mutual information of each feature of the graph neural network and characterize the feature importance. Critical features for each GNN model across all scenarios are listed in Table 2.6 (FIG. 2.1.6). Structural features such as logic depth and the number of fan-outs, and parasitic features consistently rank as the greatest contributing features of the model. The estimated arrival time determined after completion of the initial stage of the design flow is a significant feature of both the deep GCN neural network architecture and the wide and deep GCN neural network architecture and results in a mutual importance score greater than 0.67 across all models. The deep GCN model includes greater variation in the important gate features, which include the DFDQ1, NR3D0, ND2D1, and CKND3 standard cells. The wide and deep GCN only lists DFDQ1 as the sole important gate feature. There are fewer features with mutual importance greater than 0.4 in the wide and deep GCN models, which suggests the models leverage fewer features for prediction, especially for the estimation of the arrival time in the initial design stage.

While much of the evaluation herein focuses on gate arrival time prediction, the same architecture and adaptation methodology are applicable to other timing and physical metrics, such as total power, interconnect capacitance, and signal slew.

For example, a source model trained on arrival time in a 65 nm node may be adapted to predict power in a 28 nm node with similar gains in mean absolute percentage error reduction.

### Conclusion

In this disclosure, a methodology that uses a wide and deep graph regression model is proposed to predict the post routing gate arrival time from a timing path generated post-floorplanning, postplacement, and post-CTS of the IC design flow. Graph representations of netlists and timing paths for ISCAS'89 benchmark circuits generated from commercial EDA and STA tools are used as datasets, and an error analysis is performed to obtain baseline errors from the commercial tools. When validating the trained model, an average improvement of 65.58% in MAPE is observed when predicting the post-routing arrival time after completing floorplanning and 13.53% when predicting the post-routing arrival time post-placement. By subdividing the dataset based on overall netlist size, an average improvement of 34.83% for post floorplan prediction and 22.17% for post-placement prediction is observed as compared to the baseline. The proposed machine learning methodology largely reduces errors and outperforms the baseline across all modeling scenarios except for the post-CTS to post routing predictions, for which the commercial tool already provides a low baseline error.

While the invention has been described with reference to the embodiments above, a person of ordinary skill in the art would understand that various changes or modifications may be made thereto without departing from the scope of the claims.

We claim:

1. A method for predicting a post-routing timing metric of an integrated circuit implemented in a first semiconductor process node, comprising:
training a graph-based neural network model on a dataset of timing path graphs generated from designs implemented in a second semiconductor process node;
adapting the trained model for the first semiconductor process node by applying at least one of: fine-tuning one or more layers, freezing one or more layers, modifying the model architecture, or re-parameterizing model weights; and
outputting a predicted post-routing timing metric for the first semiconductor process node.

2. The method of claim 1, wherein the timing metric comprises at least one of: gate arrival time, path delay, signal slew, total power, interconnect capacitance, or routing congestion level.

3. The method of claim 1, wherein the first and second semiconductor process nodes differ by at least one full generation of technology scaling, including 90 nm to 45 nm, 65 nm to 28 nm, or 16 nm to 5 nm.

4. The method of claim 1, wherein adapting the trained model comprises freezing all layers of the model trained on the second process node and adding a fine-tunable layer.

5. The method of claim 4, wherein the added fine-tunable layer comprises between 8 and 128 neurons and is trained using stochastic gradient descent, Adam, or RMSProp optimization with a learning rate between 0.001 and 0.05 and a decay rate between 85% and 99%.

6. The method of claim 1, wherein the timing path graphs are generated from at least one of: Verilog netlists, DEF physical layout files, GDSII layout files, SPEF parasitic files, static timing analysis reports, or manufacturing variation data.

7. The method of claim 1, wherein the adaptation reduces mean absolute percentage error by at least 20% compared to direct use of the trained model without adaptation.

8. The method of claim 1, wherein the dataset for the first semiconductor process node is generated using automated electronic design automation tool flows and requires less than 10% of the time to train a model from scratch.

9. The method of claim 1, wherein the graph-based neural network comprises at least one graph convolutional layer, message-passing layer, graph attention layer, or transformer-based graph processing layer.

10. A non-transitory computer-readable medium storing instructions that, when executed by a processor, cause the processor to perform the method of claim 1.

11. A method for predicting a post-routing timing metric from an earlier stage of an integrated circuit design flow, comprising:
generating a timing path graph representation from netlist and design data of the integrated circuit;
populating nodes of the graph with a feature set including at least one feature from each of: setup features, standard cell features, structural features, timing features, and parasitic features;
inputting the timing path graph into a graph-based machine learning model; and
outputting a predicted post-routing timing metric.

12. The method of claim 11, wherein the earlier stage comprises at least one of: post-floorplanning, post-placement, post-clock-tree-synthesis, or post-global-routing.

13. The method of claim 11, wherein the timing path graph is derived from a netlist graph by extracting subgraphs corresponding to critical timing paths identified in a static timing analysis report.

14. The method of claim 11, wherein the graph-based machine learning model comprises at least one of: a graph convolutional network, a graph attention network, a message-passing neural network, or a hybrid architecture combining graph-based layers with fully connected layers.

15. The method of claim 11, wherein the machine learning model is a wide-and-deep regression model that includes the earlier-stage predicted timing metric as an input to the final layer.

16. The method of claim 11, wherein training the model comprises using stochastic gradient descent, Adam, or RMSProp optimization with a batch size between 128 and 2048 and a decaying learning rate.

17. The method of claim 11, wherein feature importance is computed using an explainable artificial intelligence algorithm to determine contributions to prediction accuracy.

18. The method of claim 11, wherein parasitic capacitance and resistance values are extracted from SPEF files, DSPF files, or equivalent parasitic extraction formats and used as node features.

19. The method of claim 11, wherein the method achieves a mean absolute percentage error improvement of at least 50% over a baseline static timing analysis prediction when predicting after floorplanning.
